(19) United States
(12) Patent Application Publication
(10) Pub. No.: US 2012/0025442 A1
(43) Pub. Date: Feb. 2, 2012

(54) SHEET PROCESSING APPARATUS AND SHEET PROCESSING METHOD

(75) Inventor: Tatsuhisa NARAOKA, Shizuoka (JP)

(73) Assignees: Toshiba Tec Kabushiki Kaisha, Tokyo (JP); Kabushiki Kaisha Toshiba, Tokyo (JP)

(21) Appl. No.: 13/190,473

(22) Filed: Jul. 25, 2011

Related U.S. Application Data
(60) Provisional application No. 61/368,606, filed on Jul. 28, 2010.

(51) Int. Cl. B41F 13/66; B65H 9/04; B65H 39/10; B65H 31/00

(52) U.S. Cl. 270/58.12; 271/207; 271/254; 270/58.27

(57) ABSTRACT

A sheet processing apparatus according to an embodiment includes a post-processing unit that post-processes a sheet carried from an image forming apparatus, a sheet discharge unit that discharges the post-processed sheet to an outlet, a storage tray that stacks the sheet discharged from the outlet and can move in the vertical direction, and a first transverse alignment portion that is provided at the storage tray and aligns the sheet discharged from the outlet from the width direction.

### CROSS-REFERENCE TO RELATED APPLICATION

This application is based upon and claims the priority of U.S. Provisional Application No. 61/368,606, filed on Jul. 28, 2010, the entire contents of which are incorporated herein by reference.

### FIELD

Embodiments described below relate to a sheet processing apparatus and a sheet processing method of performing a post-process such as stapling for a sheet discharged from an image forming apparatus such as a copier, a printer, a multifunction peripheral (MFP) or the like.

### BACKGROUND

An image forming apparatus (for example, an MFP) is connected to a sheet processing apparatus on the rear side thereof in order to post-process a sheet after an image is formed thereon. The sheet processing apparatus is called a finisher, and staples and sorts sheets sent from the MFP so as to perform discharging to a storage tray.

The finisher is provided with transverse alignment plates for controlling positions of sheets in the width direction, aligns the sheets, and carries the sheets to a stapler so as to staple. The transverse alignment plates are also used to sort and discharge the sheets.

Meanwhile, the sheet processing apparatus in the related art aligns the sheets using the transverse alignment plates and discharges the sheets to the storage tray; however, there are cases where the sheets are not in order during the discharge, and thus cannot be properly discharged to the storage tray. Therefore, a new improvement is required in order to increase the alignment of sheets.

### BRIEF DESCRIPTION OF THE DRAWINGS

FIG. 1 is a configuration diagram illustrating a sheet processing apparatus and an image forming apparatus according to an embodiment.

FIG. 2 is a configuration diagram of the sheet processing apparatus (finisher) according to an embodiment.

FIG. 3 is a perspective view when the finisher is viewed from an outlet side according to an embodiment.

FIG. 4 is a perspective view illustrating transverse alignment plates and a storage tray of the finisher according to an embodiment.

FIG. 5 is a plan view illustrating a driving portion of inner alignment plates according to the embodiment.

FIG. 6 is a plan view illustrating a driving portion of outer alignment plates according to the embodiment.

FIG. 7A and FIG. 7B are plan views illustrating a discharge operation of a sheet according to the embodiment.

FIG. 8 is a block diagram illustrating a control system of the image forming apparatus and the finisher.

### DETAILED DESCRIPTION

A sheet processing apparatus according to an embodiment includes, a post-processing unit that post-processes a sheet carried from an image forming apparatus, a sheet discharge unit that discharges the post-processed sheet to an outlet, a storage tray that stacks the sheet discharged from the outlet and can move in the vertical direction, and a first transverse alignment portion that is provided at the storage tray and aligns the sheet discharged from the outlet from the width direction.

Hereinafter, a sheet processing apparatus according to an embodiment will be described in detail with reference to the drawings. In addition, like numbers reference like elements in the drawings.

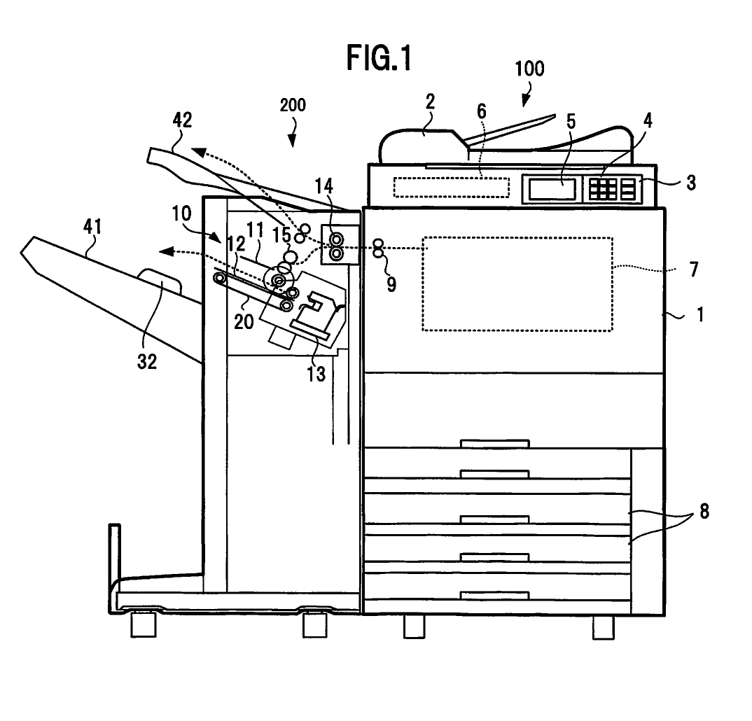

FIG. 1 is a configuration diagram illustrating a sheet processing apparatus and an image forming apparatus. In FIG. 1, an image forming apparatus 100 is, for example, an MFP (Multi-Function Peripheral), a printer, or a copier. A sheet processing apparatus 200 post-processing a sheet is disposed so as to be adjacent to the image forming apparatus 100. The sheet processing apparatus 200 is referred to as a finisher 200 hereinafter.

A sheet on which an image is formed by the image forming apparatus 100 is carried to the finisher 200. The finisher 200 performs a post-process (finishing) for the sheet supplied from the image forming apparatus 100, and, for example, performs stapling, sorting, or the like for the sheet.

A document table is disposed on a main body 1 of the image forming apparatus 100, and an automatic document feeder (ADF) 2 is provided so as to be opened and closed on the document table. An operation panel 3 is provided on the upper portion of the main body 1. The operation panel 3 has various operation keys 4, and a touch panel type display portion 5.

The main body 1 has a scanner unit 6 and a printer unit 7 therein, and a plurality of cassettes 8 containing sheets with various kinds of sizes is provided at the lower portion of the main body 1. The scanner unit 6 reads a document sent by the ADF 2, or a document placed on the document table.

The printer unit 7 includes a photoconductive drum, laser, and the like, exposes a surface of the photoconductive drum by scanning the surface with laser beams from the laser, and forms an electrostatic latent image on the photoconductive drum. A charger, a developing device, a transfer device, and the like are disposed around the photoconductive drum, the electrostatic latent image on the photoconductive drum is developed by the developing device, and a toner image is formed on the photoconductive drum. The toner image is transferred onto a sheet by the transfer device. The sheet onto which the toner image is transferred is heated by a fixing device, and the toner image is fixed to the sheet. The configuration of the printer unit 7 is not limited to the above-described example but may take a variety of forms.

The sheet on which the image is formed by the printer unit 7 is carried to the finisher 200 by a discharge roller 9. The finisher 200 has, for example, a staple unit 10 which staples a bundle of sheets. The sheets post-processed by the finisher 200 are discharged to a storage tray 41 or a fixed tray 42. The storage tray 41 can move in the vertical direction.

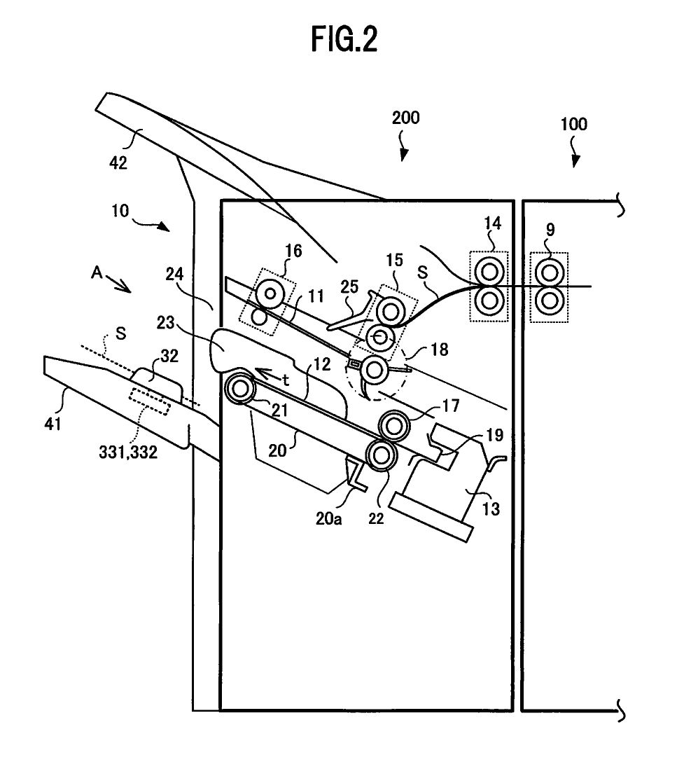

FIG. 2 is a configuration diagram of the finisher 200. The staple unit 10 has a stand-by tray 11, a process tray 12, and a stapler 13. The sheet S discharged by the discharge roller 9 of the image forming apparatus 100 is received by an inlet roller 14 provided at an entrance of the staple unit 10. The inlet roller 14 includes an upper roller and a lower roller, and is driven by a motor.

A paper feeding roller 15 is provided downstream of the inlet roller 14, and the sheet S received by the inlet roller 14 is sent to the stand-by tray 11 via a paper feeding roller 15. The paper feeding roller 15 includes an upper roller and a lower roller, and the paper feeding roller 15 is driven by a motor. The process tray 12 which stacks the sheet S dropping from the stand-by tray 11 is disposed at the lower side of the stand-by tray 11.

The stand-by tray 11 stacks the sheet S and has a structure capable of being opened. When a predefined number of sheets S are accumulated, the stand-by tray 11 is opened, and the sheet S drops toward the process tray 12 due to the self weight or a dropping assistance member which forces the sheet S to drop. The process tray 12 supports the sheet S while the stapler 13 staples the sheet S.

The dropped sheet on the process tray 12 is guided to the stapler 13 by a roller 17 and undergoes stapling. The roller 17 is driven by a motor, and rotates in the reverse direction when the sheet S is guided to the stapler 13 and the stapled sheet S is discharged.

When the sheet is stapled, a plurality of dropped sheets S to the process tray 12 from the stand-by tray 11 are aligned in the longitudinal direction which is a carrying direction, also aligned in the transverse direction perpendicular to the carrying direction, and then stapled. A transverse alignment portion 23 is provided in order to align the sheets S in the transverse direction. The transverse alignment portion 23 aligns and sorts the sheets S. The stapler 13 and the transverse alignment portion 23 constitute a post-processing unit, and perform a post-process such as stapling or sorting.

In addition, in order to assist the sheet S in dropping to the process tray 12, a rotatable paddle 18 is provided at the position where the rear end of the sheet S drops. The paddle 18 is installed at a rotation shaft, makes the sheet S dropping from the stand-by tray 11 fall on the process tray 12, and sends the sheet S in the direction of the stapler 13.

A stopper 19 which limits the rear end position of the sheet S is provided at the end part of the stapler 13 side of the process tray 12. Further, a carrying belt 20 is provided so as to carry the sorted or stapled sheets S to the storage tray 41. The carrying belt 20 hangs between pulleys 21 and 21, and the carrying belt 20 is provided with a claw member 20a which suspends and sends the rear end of the sheet S.

When the carrying belt 20 rotates in an arrow t direction, the sheet S is discharged from an outlet 24 to the storage tray 41. The storage tray 41 moves in the vertical direction and receives the sheet S by a motor. The carrying belt 20 and the claw member 20a constitute a sheet discharge unit for guiding the stapled sheet S to the outlet 24.

In addition, if the sheets S stacked in the stand-by tray 11 are not stapled but are discharged to the storage tray 41, the sheets S do not drop to the process tray 12 but are discharged by a rotation roller 16. Further, the sheet S which is not required to be stapled may be discharged to the fixed tray 42. A carrying path is provided in order to guide the sheet S to the fixed tray 42. An assistance arm 25 is installed so as to rock at an installation shaft of the upper roller of the paper feeding roller 15. The assistance arm 25 protrudes toward the discharge side of the paper feeding roller 15, and tightly presses the rear end side of the sheet S discharged from the paper feeding roller 15 toward the stand-by tray 11 so that the rear end side is not floated.

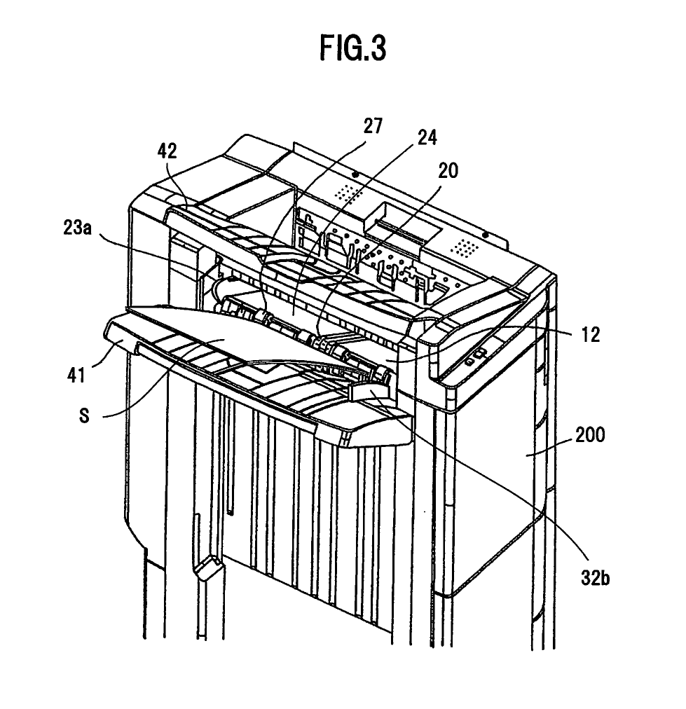

FIG. 3 is a perspective view when the finisher 200 is viewed from an arrow A direction in FIG. 2. The process tray 12 is seen from an opening portion 24 of the finisher 200. The carrying belt 20 is disposed at the central part of the process tray 12, and transverse alignment plates 23a and 23b of the transverse alignment portion 23 are disposed at the left and right end parts of the process tray 12. However, in FIG. 3, the transverse alignment plate 23b is not seen since the transverse alignment plate 23b is hidden in the finisher main body.

The sheet S discharged from the finisher 200 is discharged to the storage tray 41 and stacked. In addition, the sheet S may be discharged singly, or may be discharged as a bundle of stapled sheets. The storage tray 41 is provided with a transverse alignment portion 32 which aligns the discharged sheets in the width direction. The transverse alignment portion 32 has a pair of transverse alignment plates 32a and 32b which can move in the direction perpendicular to the discharge direction of the sheets. In FIG. 3, the transverse alignment plate 32a is hidden by the sheet S.

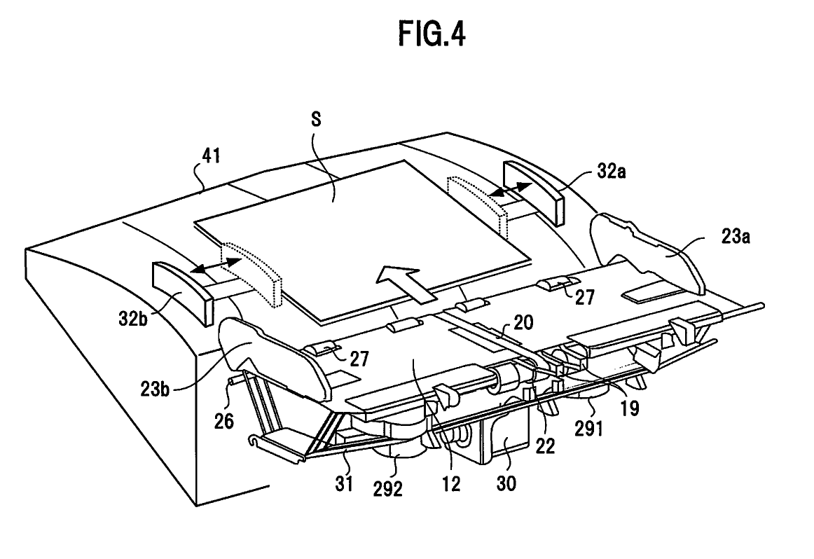

FIG. 4 is a perspective view illustrating a configuration of main portions according to the embodiment, and is a diagram when the storage tray 41 is viewed from the process tray 12 side. In FIG. 4, a shaft 26 is disposed to be perpendicular to the carrying direction of the sheet S, the pulley 21 (FIG. 2) is installed at the intermediate part of the shaft 26, and the carrying belt 20 hangs between the pulley 21 and the pulley 22. The carrying belt 20 is rotated by a motor 30, and rotatably moves along the discharge direction of the sheet in a circulated manner. Further, a plurality of discharge rollers 27 is installed at the shaft 26 and rotates when the sheet S is discharged to the storage tray 41.

The process tray 12 is provided with the transverse alignment portion 23. The transverse alignment portion 23 has the pair of transverse alignment plates 23a and 23b provided at both sides of the process tray 12. The transverse alignment plates 23a and 23b are slidable in the width direction (direction perpendicular to the carrying direction) of the sheet. The transverse alignment plates 23a and 23b align dropped sheets from the stand-by tray 11 (FIG. 2). The transverse alignment plates 23a and 23b are moved in parallel to the shaft 26 by the rotation of motors 291 and 292. The motors 291 and 292 are installed at a frame 31.

In addition, the storage tray 41 is provided with the transverse alignment plates 32a and 32b constituting the transverse alignment portion 32. The transverse alignment plates 32a and 32b can move in the direction perpendicular to the discharge direction of the sheet.

The sheets S which are post-processed by the finisher 200 are aligned by the transverse alignment plates 23a and 23b for the post-process and then are discharged to the storage tray 41, and further are aligned by the transverse alignment plates 32a and 32b on the storage tray 41. The transverse alignment plates 23a and 23b may move in synchronization with the transverse alignment plates 32a and 32b. In addition, the transverse alignment plates 32a and 32b move with the passage of a preset time, that is, with some delay time after the transverse alignment plates 23a and 23b align the sheet S through the movement. The transverse alignment plates 23a and 23b and the transverse alignment plates 32a and 32b are respectively driven by individual driving sources.

In addition, in the following description, for convenience, the transverse alignment plates 23a and 23b are referred to as inner alignment plates, and the transverse alignment plates 32a and 32b are referred to outer alignment plates.

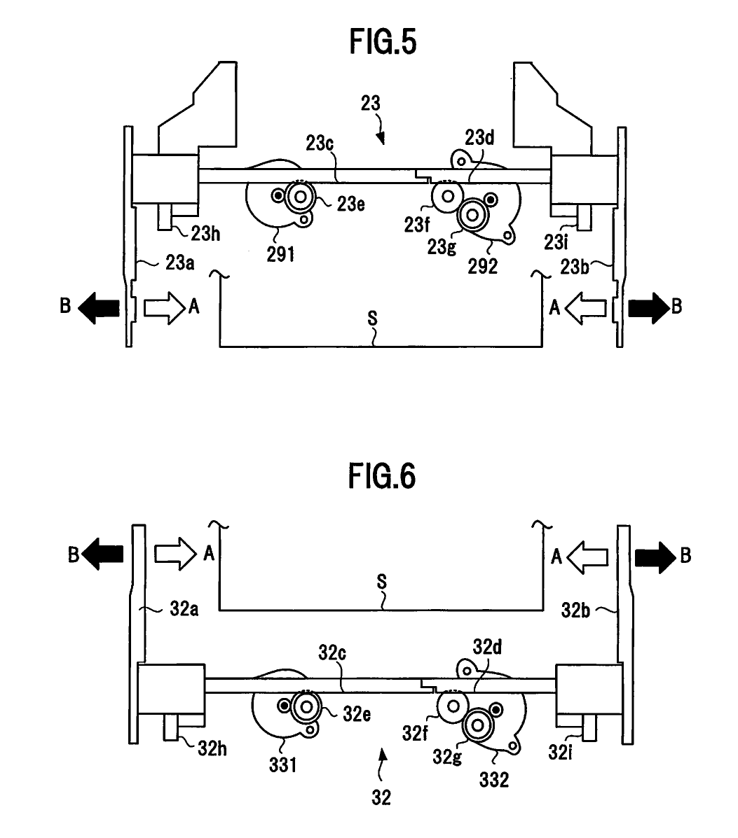

FIG. 5 is a plan view illustrating the transverse alignment portion 23, and mainly shows a configuration of a driving portion of the inner alignment plates 23a and 23b. FIG. 6 is a plan view illustrating the transverse alignment portion 32, and mainly shows a configuration of a driving portion of the outer alignment plates 32a and 32b.

In FIG. 5, the transverse alignment portion 23 includes the pair of inner alignment plates 23a and 23b disposed at both sides of the process tray 12, racks 23c and 23d coupled with the inner alignment plates 23a and 23b, and gears 23e and 23f engaged with the racks 23c and 23d.

The motors 291 and 292 which are driving sources are provided in order to rotate the gears 23e and 23f. The rotation of the motor 291 allows the gear 23e to rotate, the rack 23c to move, and the inner alignment plate 23a to move in an arrow A or an arrow B direction. In addition, a gear 23g is provided between the motor 292 and the gear 23f.

The rotation of the motor 292 allows the gear 23g and the gear 23f to rotate, the rack 23d to move, and the inner alignment plate 23b to move in the arrow A or the arrow B direction. The inner alignment plates 23a and 23b can respectively move independently from each other in the direction (A and B directions) perpendicular to the sheet carrying direction.

Further, sensors 23h and 23i are provided around the inner alignment plates 23a and 23b, and detect home positions of the inner alignment plates 23a and 23b. The home positions of the inner alignment plates 23a and 23b are, for example, positions where the inner alignment plates 23a and 23b move to the end in the B direction, and move in the arrow A direction from the home positions depending on the sizes of sheets. If stepping motors are used as the motors 291 and 292, the movement distances of the inner alignment plates 23a and 23b can be set through the management of the number of rotations of the motors 291 and 292.

When the sheet S drops to the process tray 12, the inner alignment plates 23a and 23b are located at the stand-by positions in the arrow B direction, and are spaced apart from the sheet S in the width direction. In order to correct the misalignment in the width direction of the dropped sheet S on the process tray 12, the inner alignment plates 23a and 23b move in the arrow A direction and align the sheet S with the sheet S located therebetween in the width direction.

In addition, when the transverse alignment portion 23 sorts the sheet S, the inner alignment plates 23a and 23b stand by at the position through the movement in the arrow B direction, and, for example, with respect to one inner alignment plate 23a, the sheet S is tightly pressed to the inner alignment plate 23a by moving the other inner alignment plate 23b. Alternatively, with respect to the other inner alignment plate 23b, the sheet S is tightly pressed to the other inner alignment plate 23b by moving the one inner alignment plate 23a.

FIG. 6 is a plan view illustrating the transverse alignment portion 32, and mainly shows a configuration of a driving portion of the outer alignment plates 32a and 32b. In FIG. 6, the transverse alignment portion 32 has the pair of the outer alignment plates 32a and 32b of which a part protrudes on the upper surface of the storage tray 41. In addition, the storage tray 41 is provided with racks 32c and 32d coupled with the outer alignment plates 32a and 32b, and gears 32e and 32f engaged with the racks 32c and 32d.

Motors 331 and 332 which are driving sources are provided in order to rotate the gears 32e and 32f. The rotation of the motor 331 allows the gear 32e to rotate, the rack 32c to move, and the outer alignment plate 32a to move in the arrow A or the arrow B direction. In addition, a gear 32g is provided between the motor 332 and the gear 32f.

The rotation of the motor 332 allows the gear 32g and the gear 32f to rotate, the rack 32d to move, and the outer alignment plate 32b to move in the arrow A or the arrow B direction. The outer alignment plates 32a and 32b can respectively move independently from each other in the direction perpendicular to the sheet carrying direction.

Further, sensors 32h and 32i are provided around the outer alignment plates 32a and 32b, and detect home positions of the outer alignment plates 32a and 32b. The home positions of the outer alignment plates 32a and 32b are, for example, positions where the outer alignment plates 32a and 32b move to the end in the B direction, and move in the arrow A direction from the home positions depending on the sizes of sheets. If stepping motors are used as the motors 331 and 332, the movement distances of the outer alignment plates 32a and 32b can be set through the management of the number of rotations of the motors 331 and 332.

The outer alignment plates 32a and 32b stand by at the positions through the movement in the arrow B direction. If the sheet S is discharged to the storage tray 41, the outer alignment plates 32a and 32b move in the arrow A direction and align the sheet S with the sheet S located therebetween in the width direction.

In addition, if sorted sheets are discharged, the outer alignment plates 32a and 32b align the sheets S in the width direction through the movement of the outer alignment plate 32a and the outer alignment plate 32b.

Therefore, when the finisher 200 staples or sorts the sheets S and discharges the sheets S to the storage tray 41, the sheets on the storage tray 41 are aligned in the width direction by the outer alignment plates 32a and 32b, and thus it is possible to prevent the discharged sheets S from being in disorder.

If driving timings of the motors 291, 292, 331 and 332 are controlled such that the outer alignment plates 32a and 32b move with some delay time after the inner alignment plates 23a and 23b move, the alignment is further improved.

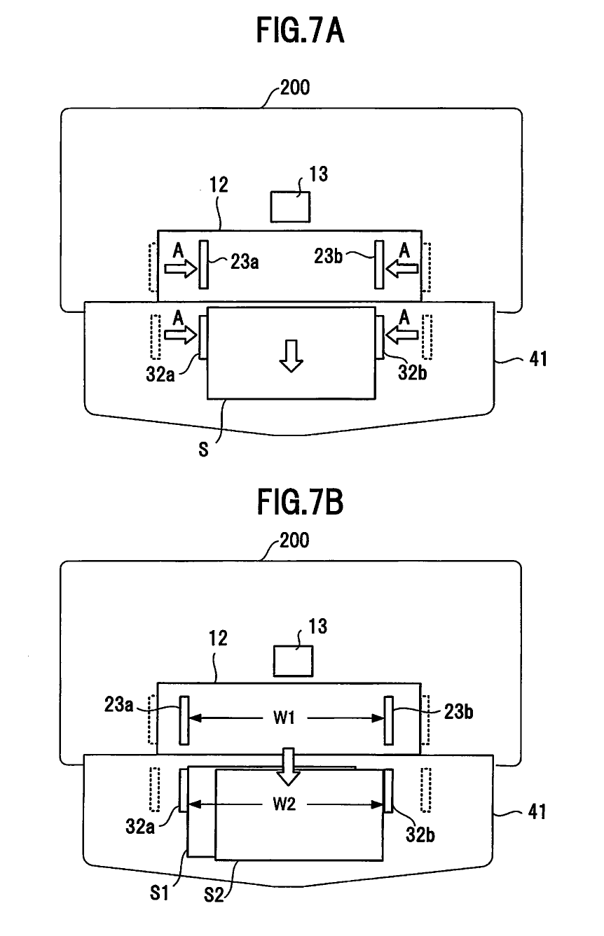

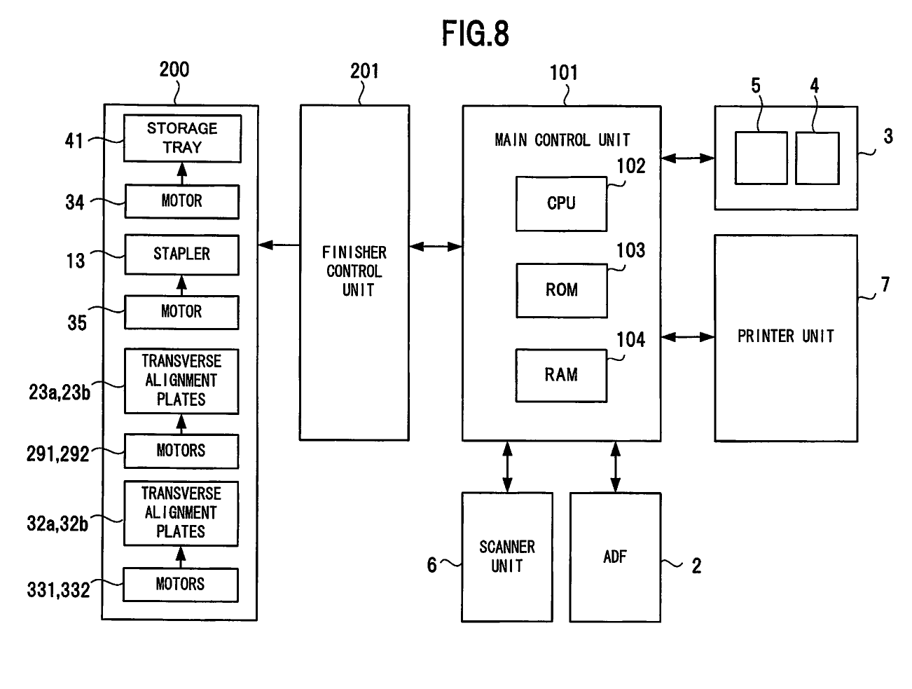

FIG. 7A is a plan view illustrating operations of the inner alignment plates 23a and 23b and the outer alignment plates 32a and 32b when the sheets S are transversely aligned and are discharged to the storage tray 41.

For example, assuming that the sheets S are moved close to the central part of the process tray 12 by the inner alignment plates 23a and 23b, aligned, and discharged. If the sheets S are discharged to the storage tray 41, the outer alignment plates 32a and 32b move the sheets S close to the central part of the storage tray 41 and align the sheets S. The outer alignment plates 32a and 32b move in the arrow A direction from the stand-by positions (dotted lines).

The inner alignment plates 23a and 23b and the outer alignment plates 32a and 32b change their aligning positions depending on the sizes of the sheets S. The outer alignment plates 32a and 32b move in the same direction so as to correspond with movement of the inner alignment plates 23a and 23b. In addition, the positions of the outer alignment plates 32a and 32b are set to correspond with the positions of the inner alignment plates 23a and 23b. In other words, in which direction the inner alignment plates 23a and 23b move and to which position the inner alignment plates 23a and 23b move are known in advance, and thus the movement and the position of the outer alignment plates 32a and 32b can be set to correspond with the movement of the inner alignment plates 23a and 23b.

FIG. 7B is a plan view illustrating operations of the inner alignment plates 23a and 23b and the outer alignment plates 32a and 32b when the sheets S are sorted and are discharged to the storage tray 41. For example, be assumed that the inner alignment plates 23a and 23b sort the sheets S1 and S2 to the central part of the process tray 12 and discharge the sorted sheets. The outer alignment plates 32a and 32b respectively move from the stand-by positions marked with the dotted lines to the positions marked with the solid lines.

In addition, it is assumed that, during the sorting of the sheets, the sort width defined by the inner alignment plate 23a when sorting the sheet S1 and the inner alignment plate 23b when sorting the sheet S2 is W1. If the outer alignment plates 32a and 32b move such that a total width W2 of the sheet S1 and the sheet S2 discharged to the storage tray 41 becomes W1≅W2, the alignment between the sheet S1 and the sheet S2 after being sorted becomes favorable.

FIG. 8 is a block diagram illustrating a control system of the image forming apparatus 100 and the finisher 200. In FIG. 8, a main control unit 101 includes a CPU 102, a ROM 103, and a RAM 104. The CPU 102 controls the image forming apparatus 100 according to a control program stored in the ROM 103. In addition, the main control unit 101 controls the operations of the ADF 2, the scanner unit 6, and the printer unit 7 in response to an operation of the operation panel 3. The RAM 104 temporarily stores control data and is used for calculation work during the control.

The operation panel 3 has a plurality of operation keys 4 and the touch panel type display portion 5, and gives various instructions for forming images. For example, an instruction for the number of copies is given using the operation keys 4, and instructions for a sheet size, the kind of sheet, stapling, sorting, and the like are given by operating the touch panel of the display portion 5.

A finisher control unit 201 controls an operation of the finisher 200 and an operation of a sheet discharge. The finisher control unit 201 is connected to the main control unit 101, and transits information along with the main control unit 101, and the image forming apparatus 100 and the finisher 200 work in cooperation.

The finisher control unit 201 drives the motor 34 which moves the storage tray 41 in the vertical direction, and controls the height of the storage tray 41 so as to match the height of the process tray 12. In addition, if there is an instruction for stapling from the operation panel 3, the stapling is executed by driving the motor 35 which controls a position of the stapler 13. Further, the transverse alignment and the sorting of the sheets S are executed by driving the motors 291 and 292 which drive the inner alignment plates 23a and 23b. The transverse alignment of the sheets S discharged on the storage tray 41 is executed by driving the motors 331 and 332 which drive the outer alignment plates 32a and 32b.

According to the embodiment described above, possible to align sheets discharged to the storage tray and stack the sheets so as not to be in disorder.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A sheet processing apparatus comprising:
a post-processing unit that post-processes a sheet carried from an image forming apparatus;
a sheet discharge unit that discharges the post-processed sheet to an outlet;
a storage tray that stacks the sheet discharged from the outlet and can move in the vertical direction; and
a first transverse alignment portion that is provided at the storage tray and aligns the sheet discharged from the outlet from the width direction.

2. The apparatus of claim 1, wherein the first transverse alignment portion has a pair of first transverse alignment plates which are movable in a direction perpendicular to the discharge direction of the sheet, and the first transverse alignment plates move between a stand-by position spaced apart from the discharged sheet in the width direction and a position where the sheet is aligned.

3. The apparatus of claim 2, wherein the first transverse alignment portion changes alignment positions of the first transverse alignment plates depending on a size of the sheet.

4. The apparatus of claim 1, further comprising a second transverse alignment portion that aligns the sheet to be post-processed from the width direction,
wherein the sheet aligned by the second transverse alignment portion is post-processed by the post-processing unit and is discharged to the storage tray, and the discharged sheet is aligned from the width direction by the first transverse alignment portion.

5. The apparatus of claim 4, wherein the first transverse alignment portion aligns the sheet discharged to the storage tray with the passage of a preset time after the second transverse alignment portion aligns the sheet.

6. The apparatus of claim 4, wherein the first transverse alignment portion has a pair of first transverse alignment plates which are movable in a direction perpendicular to the discharge direction of the sheet, and the second transverse alignment portion has a pair of second transverse alignment plates which aligns the sheet to be post-processed from the width direction, and
wherein the apparatus comprises first and second driving sources which separately drive the first transverse alignment plates and the second transverse alignment plates.

7. The apparatus of claim 6, wherein the first transverse alignment plates move in the same direction so as to correspond with movements of the second transverse alignment plates.

8. The apparatus of claim 6, wherein positions of the second transverse alignment plates are set so as to correspond with positions of the first transverse alignment plates.

9. The apparatus of claim 6, wherein the post-processing unit has a stapler which staples the sheet aligned by the second transverse alignment plates, and
wherein the first transverse alignment plates respectively align a bundle of stapled sheets discharged to the storage tray from the width direction.

10. The apparatus of claim 6, wherein the sheet is sorted by the second transverse alignment plates and is discharged to the storage tray, and is aligned by moving the first transverse alignment plates in the width direction depending on a sort width of the sorted sheet.

11. A sheet processing method comprising:
post-processing a sheet carried from an image forming apparatus with a post-processing unit;
discharging the post-processed sheet to an outlet;
stacking the sheet discharged from the outlet on a storage tray which can move in the vertical direction; and
aligning the sheet discharged from the outlet from the width direction by a first transverse alignment portion provided at the storage tray.

12. The method of claim 11, wherein the first transverse alignment portion has a pair of first transverse alignment plates which are movable in a direction perpendicular to the discharge direction of the sheet, and the first transverse alignment plates move between a stand-by position spaced apart from the discharged sheet in the width direction and a position where the sheet is aligned.

13. The method of claim 12, wherein the first transverse alignment portion changes alignment positions of the first transverse alignment plates depending on a size of the sheet.

14. The method of claim 11, wherein the sheet to be post-processed is aligned from the width direction by a second transverse alignment portion, and
wherein the sheet aligned by the second transverse alignment portion is discharged to the storage tray, and the discharged sheet is aligned from the width direction by the first transverse alignment portion.

15. The method of claim 14, wherein the first transverse alignment portion aligns the sheet discharged to the storage tray with the passage of a preset time after the second transverse alignment portion aligns the sheet to be post-processed.

16. The method of claim 14, wherein the first transverse alignment portion has a pair of first transverse alignment plates which are movable in a direction perpendicular to the discharge direction of the sheet, and the second transverse alignment portion has a pair of second transverse alignment plates which aligns the sheet to be post-processed from the width direction,
wherein the apparatus comprises first and second driving sources which separately drive the first transverse alignment plates and the second transverse alignment plates.

17. The method of claim 16, wherein the first transverse alignment plates move in the same direction so as to correspond with movements of the second transverse alignment plates.

18. The method of claim 16, wherein positions of the second transverse alignment plates are set so as to correspond with positions of the first transverse alignment plates.

19. The method of claim 16, wherein the sheet aligned by the second transverse alignment plates is stapled by the post-processing unit, and
wherein a bundle of stapled sheets discharged to the storage tray is aligned from the width direction by the first transverse alignment plates, respectively.

20. The method of claim 16, wherein the sheet is sorted by the second transverse alignment plates and is discharged to the storage tray, and is aligned by moving the first transverse alignment plates in the width direction depending on a sort width of the sorted sheet.
